(19) United States
(12) Patent Application Publication
(10) Pub. No.: US 2024/0275840 A1
(43) Pub. Date: Aug. 15, 2024

(54) METHOD AND APPARATUS OF SYNCHRONIZATION FOR MEDIA SERVICE IN COMMUNICATION SYSTEM

(71) Applicant: SAMSUNG ELECTRONICS CO., LTD., Suwon-si (KR)

(72) Inventors: Eric YIP, Suwon-si (KR); Jaeyeon SONG, Suwon-si (KR)

(21) Appl. No.: 18/436,011

(22) Filed: Feb. 7, 2024

(30) Foreign Application Priority Data
Feb. 9, 2023 (KR) 10-2023-0017120

(51) Int. Cl. H04L 65/80; H04L 65/1104; H04L 65/60

(52) U.S. Cl. CPC H04L 65/80; H04L 65/1104; H04L 65/60

(57) ABSTRACT

The disclosure relates to a 5G or 6G communication system for supporting a higher data transmission rate. According to an embodiment of the disclosure, a method performed by a node (e.g., network entity) in a communication system may be provided. The method may include: transmitting, to a first terminal, a session description protocol (SDP) offer message, wherein the SDP offer message comprises first information including a first identifier for a group of a first plurality of media streams; receiving, from the first terminal, an SDP answer message related to the SDP offer message; and transmitting, to the first terminal, at least one first media stream.

### CROSS-REFERENCE TO RELATED APPLICATIONS

This application is based on and claims priority under 35 U.S.C. § 119 to Korean Patent Application No. 10-2023-0017120 filed on Feb. 9, 2023, in the Korean Intellectual Property Office, the disclosure of which is incorporated by reference herein in its entirety.

### BACKGROUND

### 1. Field

The disclosure relates generally to wireless communication systems and more specifically, to providing media services in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node (e.g., network entity) for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure may provide a method and an apparatus for providing media services in a wireless communication system.

This disclosure is provided to address at least the above-mentioned problems and/or disadvantages and to provide at least the advantages described below.

Accordingly, an aspect of the disclosure is to provide a method performed by a node in a communication system may be provided.

According to an embodiment, the method may include transmitting, to a first terminal, a session description protocol (SDP) offer message.

According to an embodiment, the SDP offer message may include first information including a first identifier for a group of a first plurality of media streams.

According to an embodiment, the method may include receiving, from the first terminal, an SDP answer message related to the SDP offer message.

According to an embodiment, the method may include transmitting, to the first terminal, at least one first media stream.

According to an embodiment, the at least one first media stream may be related to a synchronization requirement in case that the at least one first media stream is included in the first plurality of media streams.

According to an embodiment, the method may include transmitting, to a second terminal, at least one second media stream.

According to an embodiment, in case that the at least one first media stream and the at least one second media stream are included in the first plurality of media streams, the at least one first media stream and the at least one second media stream may bel synchronized to satisfy the synchronization requirement.

According to an embodiment, in case that the at least one first media stream and the at least one second media stream are included in the first plurality of media streams, the first terminal and the second terminal may correspond to a same application function (AF) specific service function (SF) group identifier.

According to an embodiment, the first information may include information related to the synchronization requirement.

According to an embodiment, the information related to the synchronization requirement may include at least one of information regarding a synchronization jitter related to synchronization delay for the first plurality of media streams, or information regarding a synchronization latency related to latency requirement for the first plurality of media streams.

According to an embodiment, the SDP offer message may include second information including a second identifier for a multi-modal service.

According to an embodiment, the second identifier may be a same value for a plurality of sessions related to the multi-modal service and the first terminal.

According to an embodiment, the first plurality of media streams may be included in one session among the plurality of sessions.

According to an embodiment, the SDP offer message may include information related to a list of a second plurality of media streams,

According to an embodiment, the first plurality of media streams may be included in the second plurality of media streams.

According to an embodiment, the SDP answer message may include information related to the at least one first media stream included in the second plurality of media streams.

In accordance with an aspect of the disclosure, a node in a communication system may be provided.

According to an embodiment, the node may include a transceiver and a processor coupled with the transceiver.

According to an embodiment, the processor may be configured to transmit, to a first terminal, a session description protocol (SDP) offer message.

According to an embodiment, the SDP offer message may include first information including a first identifier for a group of a first plurality of media streams.

According to an embodiment, the processor may be configured to receive, from the first terminal, an SDP answer message related to the SDP offer message.

According to an embodiment, the processor may be configured to transmit, to the first terminal, at least one first media stream.

According to an embodiment, the at least one first media stream may be related to a synchronization requirement in case that the at least one first media stream is included in the first plurality of media streams.

According to an embodiment, the processor is further configured to transmit, to a second terminal, at least one second media stream.

According to an embodiment, in case that the at least one first media stream and the at least one second media stream are included in the first plurality of media streams, the at least one first media stream and the at least one second media stream may be synchronized to satisfy the synchronization requirement.

According to an embodiment, in case that the at least one first media stream and the at least one second media stream are included in the first plurality of media streams, the first terminal and the second terminal may correspond to a same application function (AF) specific service function (SF) group identifier.

According to an embodiment, the first information may include information related to the synchronization requirement.

According to an embodiment, the information related to the synchronization requirement comprises at least one of information regarding a synchronization jitter related to synchronization delay for the first plurality of media streams, or information regarding a synchronization latency related to latency requirement for the first plurality of media streams.

According to an embodiment, the SDP offer message may include second information including a second identifier for a multi-modal service.

According to an embodiment, the second identifier may be a same value for a plurality of sessions related to the multi-modal service and the first terminal.

According to an embodiment, the first plurality of media streams may be included in one session among the plurality of sessions.

According to an embodiment, the SDP offer message may include information related to a list of a second plurality of media streams.

According to an embodiment, the first plurality of media streams may be included in the second plurality of media streams.

According to an embodiment, the SDP answer message may include information related to the at least one first media stream included in the second plurality of media streams.

In accordance with an aspect of the disclosure, a method performed by a terminal in a communication system may be provided.

According to an embodiment, the method may include receiving a session description protocol (SDP) offer message.

According to an embodiment, the SDP offer message may include first information including a first identifier for a group of a first plurality of media streams.

According to an embodiment, the method may include transmitting an SDP answer message related to the SDP offer message.

According to an embodiment, the method may include receiving at least one first media stream.

According to an embodiment, the at least one first media stream may be related to a synchronization requirement in case that the at least one first media stream corresponds to the first identifier.

According to an embodiment, the first information may include information related to the synchronization requirement.

According to an embodiment, the information related to the synchronization requirement may include at least one of information regarding a synchronization jitter related to synchronization delay for the first plurality of media streams, or information regarding a synchronization latency related to latency requirement for the first plurality of media streams.

According to an embodiment, the SDP offer message may include second information including a second identifier for a multi-modal service.

According to an embodiment, the second identifier may be a same value for a plurality of sessions related to the multi-modal service and the terminal.

According to an embodiment, the first plurality of media streams may be included in one session among the plurality of sessions.

According to an embodiment, the SDP offer message may include information related to a list of a second plurality of media streams.

According to an embodiment, the first plurality of media streams may be included in the second plurality of media streams.

According to an embodiment, the SDP answer message may include information related to the at least one first media stream included in the second plurality of media streams.

In accordance with an aspect of the disclosure, a terminal in a communication system may be provided.

According to an embodiment, the terminal may include a transceiver and a processor coupled with the transceiver.

According to an embodiment, the processor may be configured to receive a session description protocol (SDP) offer message.

According to an embodiment, the SDP offer message may include first information including a first identifier for a group of a first plurality of media streams.

According to an embodiment, the processor may be configured to transmit an SDP answer message related to the SDP offer message.

According to an embodiment, the processor may be configured to receive at least one first media stream.

According to an embodiment, the at least one first media stream may be related to a synchronization requirement in case that the at least one first media stream corresponds to the first identifier.

According to an embodiment, the first information may include information related to the synchronization requirement.

According to an embodiment, the information related to the synchronization requirement may include at least one of information regarding a synchronization jitter related to synchronization delay for the first plurality of media streams, or information regarding a synchronization latency related to latency requirement for the first plurality of media streams.

According to an embodiment, the SDP offer message may include second information including a second identifier for a multi-modal service.

According to an embodiment, the second identifier may be a same value for a plurality of sessions related to the multi-modal service and the terminal.

According to an embodiment, the first plurality of media streams may be included in one session among the plurality of sessions.

According to an embodiment, the SDP offer message may include information related to a list of a second plurality of media streams.

According to an embodiment, the first plurality of media streams may be included in the second plurality of media streams.

According to an embodiment, the SDP answer message may include information related to the at least one first media stream included in the second plurality of media streams.

According to an embodiment, a method performed by a base station may be provided.

According to an embodiment, the method may include receiving, from a node, a session description protocol (SDP) offer message.

According to an embodiment, the SDP offer message may include first information including a first identifier for a group of a first plurality of media streams.

According to an embodiment, the method may include transmitting, to a terminal, the SDP offer message.

According to an embodiment, the method may include receiving, from the terminal, an SDP answer message related to the SDP offer message.

According to an embodiment, the method may include transmitting, to the node, the SDP answer message.

According to an embodiment, the method may include receiving, from the node, at least one first media stream.

According to an embodiment, the method may include transmitting, to the terminal, the at least one first media stream.

According to an embodiment, the at least one first media stream may be related to the synchronization requirement in case that the at least one first media stream is included in the first plurality of media streams.

According to an embodiment, a base station in a communication system may be provided.

According to an embodiment, the base station may include a transceiver and a processor coupled with the transceiver.

According to an embodiment, the processor may be configured to receive, from a node, a session description protocol (SDP) offer message.

According to an embodiment, the SDP offer message may include first information including a first identifier for a group of a first plurality of media streams.

According to an embodiment, the processor may be configured to transmit, to a terminal, the SDP offer message.

According to an embodiment, the processor may be configured to receive, from the terminal, an SDP answer message related to the SDP offer message.

According to an embodiment, the processor may be configured to transmit, to the node, the SDP answer message.

According to an embodiment, the processor may be configured to receive, from the node, at least one first media stream.

According to an embodiment, the processor may be configured to transmit, to the terminal, the at least one first media stream.

According to an embodiment, the at least one first media stream may be related to the synchronization requirement in case that the at least one first media stream is included in the first plurality of media streams.

The disclosure may provide a method and an apparatus for providing media services.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a 3G network laccording to an embodiment of the present disclosure.

FIG. 2 illustrates a structure of a 4G network (or a LTE network) according to an embodiment of the present disclosure.

FIG. 3 illustrates a structure of a voice and video codec of a VOLTE supported terminal and an RTP/UDP/IP protocol according to an embodiment of the present disclosure.

FIG. 4a illustrates a structure of a 5G network according to an embodiment of the present disclosure.

FIG. 4b illustrates an architecture of IMS network according to an embodiment of the present disclosure.

FIG. 4c illustrates a structure of a communication network according to an embodiment of the present disclosure.

FIG. 5 illustrates a procedure for a transmitting terminal and a receiving terminal to negotiate a transmission method of a conversational service using the IMS according to an embodiment of the present disclosure.

FIG. 6a illustrates a procedure for establishing an SDP answer by the receiving terminal from an SDP offer transmitted by the transmitting terminal according to an embodiment of the present disclosure.

FIG. 6b illustrates a procedure for establishing the SDP answer by the receiving terminal from the SDP offer transmitted by the transmitting terminal according to an embodiment of the present disclosure.

FIG. 7 illustrates a communication system for media services according to an embodiment of the present disclosure.

FIG. 8 illustrates a communication system for media services according to an embodiment of the present disclosure.

FIG. 9 illustrates a communication system for media services according to an embodiment of the present disclosure.

FIG. 10 illustrates an operation for a UE according to an embodiment of the present disclosure.

FIG. 11 illustrates an operation for a MRF according to an embodiment of the present disclosure.

FIG. 12 illustrates an operation for a UE according to an embodiment of the present disclosure.

FIG. 13 illustrates an operation for a MRF according to an embodiment of the present disclosure.

FIG. 14 illustrates a method of a UE and a node according to an embodiment of the present disclosure.

FIG. 15 illustrates an electronic device according to an embodiment of the present disclosure.

FIG. 16 illustrates a node according to an embodiment of the present disclosure.

### DETAILED DESCRIPTION

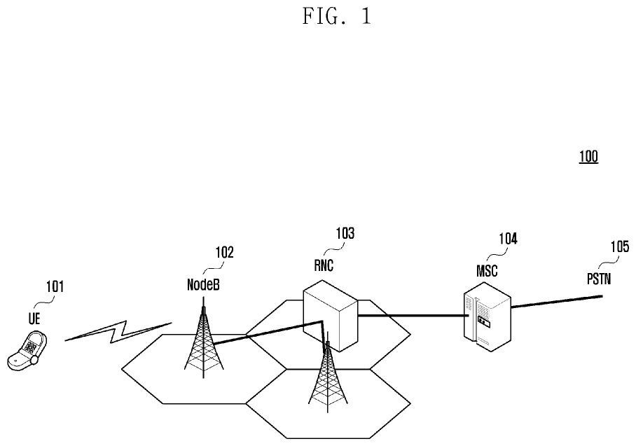

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

FIGS. 1 through 16, described below, and the various embodiments used to describe the principles of the disclosure are by way of illustration only and should not be construed in any way to limit the scope of the disclosure. Those skilled in the art will understand that the principles of the disclosure may be implemented in any type of suitably arranged device or system.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the disclosure may be implemented in 5G systems. However, the disclosure is not limited to 5G systems, or the frequency bands associated therewith, and embodiments of the disclosure may be utilized in connection with any frequency band. For example, aspects of the disclosure may also be applied to deployment of 5G communication systems, 6G or even later releases which may use terahertz (THz) bands.

The disclosure relates to a method and an apparatus of synchronization for multi device, multi-modal real time XR media services. The disclosure relates to 5G network systems for multimedia, quality of service (QOS), SDP negotiation for XR real time communication media services, media codec adaptation for XR media, traffic rate adaptation for XR media, layered codec support for XR media SDP negotiation.

3GPP standard specification TS 26.114 defines SDP negotiation and corresponding SDP attributes and parameters for media for real time communication. System aspects (SA)2 is commencing study on XR and media services, in particular the support of a protocol data unit (PDU) set concept, allowing for PDU set integrated packet handling and differentiated PDU set handling by radio access network (RAN). Such PDU set packet handling is a mechanism for media adaptation.

The disclosure may provide several embodiments which allows user equipment (UE, terminal) clients or core network (e.g., media resource function, MRF) clients to enable similar bandwidth adjustments for media (in a way, adaptation) through the SDP negotiation procedure.

Media adaptation through PDU set packet dropping by the physical layer (RAN) has several potential problems:
Grouping I/P frames and B frames separately into different PDU sets creates extra processing constraints on both codec output and decoder input latencies due to mis-match between PDU set ordering and group of pictures (GoP) structure; and/or
Exposure of such media level application (e.g., down to NAL unit header info) means parsing multiple packet layers to identify such information.

The necessary parameters associated with the enablement of a PDU set (such as PDU set size, etc) are very implementation specific, for example knowing the size of a PDU set typically requires the encoding of a whole GoP by the encoder, depending on the GoP structure, thus introducing delays in the encapsulation pipeline (e.g., real-time transport protocol (RTP) header) of the corresponding PDU set size parameters.

Current SDP negotiation procedures and media attributes/parameters do not support selection, or reception of multiple media lines (m-lines) which correspond to a same media presentation (e.g., multiple media lines which are used to decode one 2D video or 3D video).

The disclosure introduces an SDP attribute and corresponding parameters to support multiple media lines (and/or multiple media streams) corresponding to the same media presentation, where certain media lines may be independently decodable, and others only dependently decodable (e.g., such as a layered codec). Each of the multiple media lines or layers may also have a priority associated with the multiple media to indicate its own priority of selection or importance when session bandwidth is insufficient. Namely:

An XR priority group which groups multiple media lines associated to a single media type presentation (e.g., 2D video, 3D video, audio etc.) when decoded; and/or

An XR priority attribute which describes the dependency (whether the m-line is independently decodable or not), as well as the priority of the m-line within the XR priority group.

According to disclosure, the following may be provided:
Support of XR media adaptation at the SDP signalling level, using layered XR media codecs; and/or
Selection of such adaptation through dependency (independently decodable or not) and priority parameters.

FIG. 1 illustrates a structure of a 3G network 100 according to an embodiment of the present disclosure.

Referring FIG. 1, the 3G network 100 may include a user equipment (UE) 101, a base station (e.g., NodeB) 102, a radio network controller (RNC) 103, and a mobile switching center (MSC) 104.

The 3G network 100 may be connected to another mobile communication network and/or a public switched telephone network (PSTN) 105. In such the 3G network 100, voice may be compressed and/or restored with an adaptive multi-rate (AMR) codec. The AMR codec may be installed in a terminal (e.g., the UE 101) and the MSC 104 to provide a two-way call service. The MSC 104 may convert the voice compressed in the AMR codec into a pulse-code modulation (PCM) format and may transmit the voice in the PCM format to the PSTN 104. Or vice versa, the MSC 104 may receive the voice in the PCM format from the PSTN 104, may compress the voice in the PCM format into the AMR codec, and may transmit the voice compressed into the AMR codec to the base station.

The RNC 103 may control the call bit rate of the voice codec installed in the UE 101 and the MSC 104 in real time using the codec mode control (CMC) message.

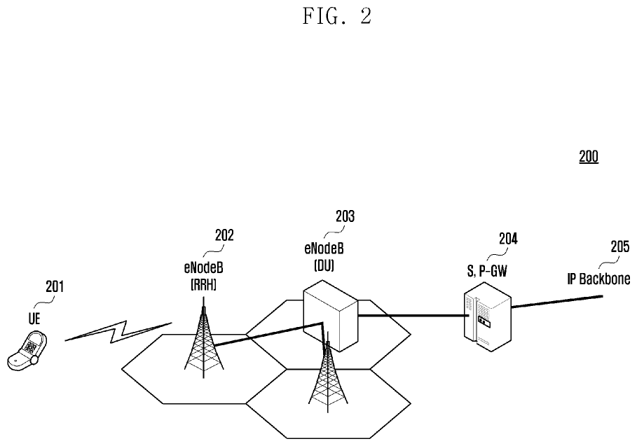

FIG. 2 illustrates a structure of a 4G network (or a long-term evolution (LTE) network) 200 according to an embodiment of the present disclosure.

Referring FIG. 2, the 4G network 200 may include a UE 201, a base station 202, 203 (e.g., an enhanced NodeB (eNB)) and a gateway 204 (e.g., serving-gateway (S-GW) and/or packet-gateway (P-GW)).

In a packet-switched network introduced in 4G, the voice codec may be installed only in a terminal (e.g., the UE 201) and a voice frame compressed at intervals of 20 ms (milliseconds) may not be restored at the base station 202, 203 or a network node (e.g., at least one gateway 204) located in the middle of the transmission path and may be transmitted to a counterpart terminal.

The voice codec may be installed only in the UE 201, and the UE 201 may adjust the voice bit rate of the counterpart terminal using a codec mode request (CMR) message.

The base station 202, 203 may be divided into a remote radio head (RRH) 202 (e.g., BS) dedicated to radio frequency (RF) functions and a digital unit (DU) 203 (e.g., BS) dedicated to modem digital signal processing. The base station 202, 203 may be connected to an internet protocol (IP) backbone network 205 through the S-GW and the P-GW. The IP backbone network may be connected to the mobile communication network and/or Internet of other service providers.

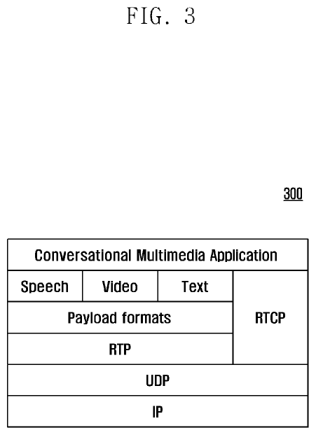

FIG. 3 illustrates a structure 300 of a voice and video codec of a voice over LTE (VOLTE) supported terminal and a real-time transport protocol (RTP)/user datagram protocol (UDP)/IP protocol according to an embodiment of the present disclosure.

Referring FIG. 3, the IP protocol located at the bottom of this structure may be connected to a packet data convergence protocol (PDCP) located at the top of the protocol structure. The RTP/UDP/IP header may be attached to a compressed media frame in the voice and video codec and transmitted to the counterpart terminal through a network (e.g., LTE network). In addition, the counterpart terminal may receive the media packet compressed and transmitted from the network, may restore media, listen to a speaker and a display, and view the media. At this time, even if the compressed voice and video packet do not arrive at the same time, timestamp information of the RTP protocol header may be used to synchronize the two media to listen and watch.

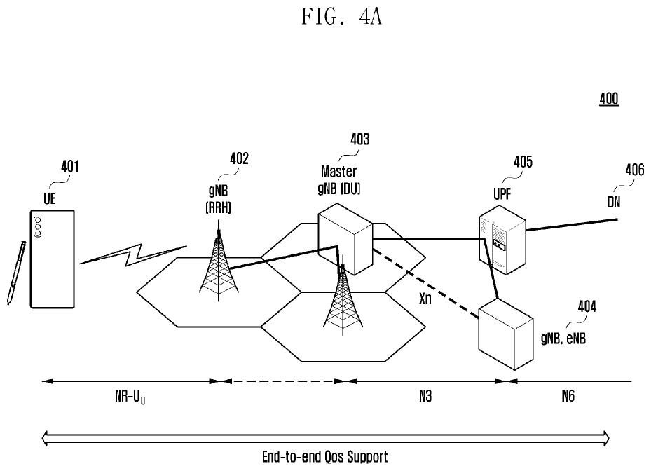

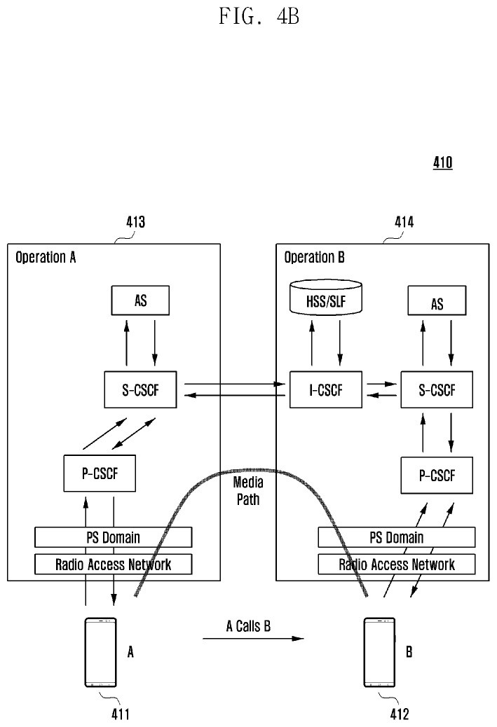

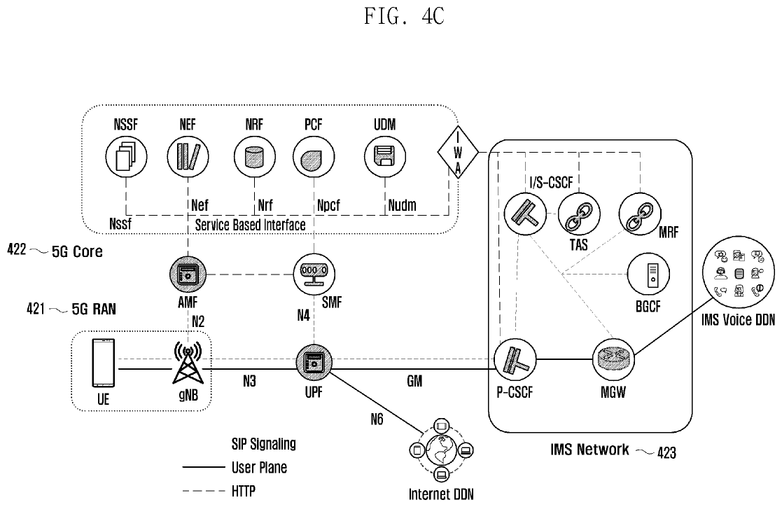

FIG. 4a illustrates a structure of a 5G network 400 according to an embodiment of the present disclosure. FIG. 4a shows a situation in which media from, and to a UE is transmitted using a 5G network.

Referring FIG. 4a, the 5G network 400 may include a UE 401, a base station 402, 403, 404 (e.g., gNB) and a core network (at least user plane function (UPF) 405). The 5G nodes (e.g., network entities) corresponding to the eNB 202, 203, S-GW and P-GW 204 of the LTE network are gNB 402, 403, 404, UPF 405, and data network (DN) 406, respectively. In this case, conversational media, including video and audio, may be transmitted using the 5G network 400. Related to an embodiment of the disclosure, additionally data related to an artificial intelligence (AI) model (e.g., model data as well as related intermediate data, etc.) may also be transmitted using the 5G network.

FIG. 4b illustrates an architecture of IP multimedia subsystem (IMS) network 410 according to an embodiment of the present disclosure.

Referring FIG. 4b, the IMS network 410 may include IMS entities from two different operators during a conversational call between two UEs (UE A 411 and UE B 412). The UE A 411 may communicate with the UE B 412 through operator A 413 and operator B 414. The 5G core (5GC) functional entities are not illustrated in the FIG. 4b. The IMS entities may be included in the operator A 413 and/or operator 414. The IMS entities may include at least one of a proxy call session control function (P-CSCF), an interrogating CSCF (I-CSCF), a serving CSCF (S-CSCF), an application server (AS) or a home subscriber server (HSS) (HSS/SLF (subscriber location function)). A media path shown in the FIG. 4b represents an actual flow of media data such as (voice) audio media, video media etc.

FIG. 4c illustrates a structure of a communication network 420 according to an embodiment of the present disclosure.

Referring FIG. 4c, the communication network 420 may include various function entities within and between the 5G RAN 421, 5G Core 422, and the IMS network 423. The entities associated with the disclosure for SDP negotiation may include the UE in the 5G RAN 421 and the MRF (media resource function) in the IMS network 423.

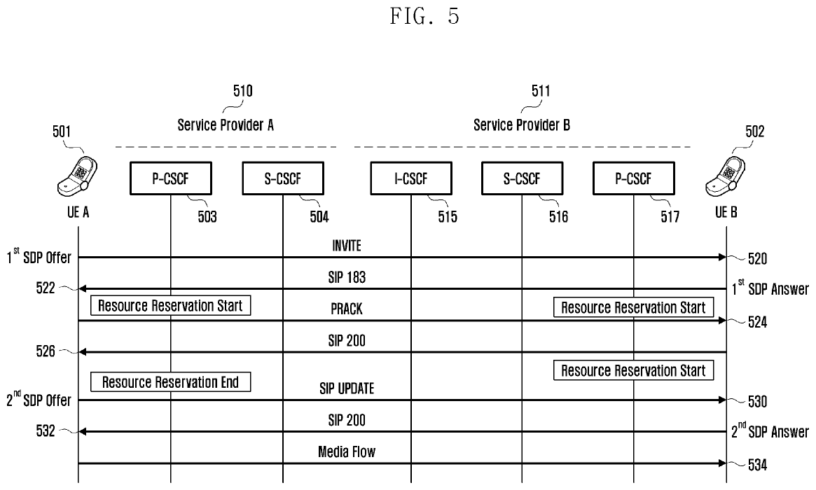

FIG. 5 illustrates a procedure for a transmitting terminal and a receiving terminal to negotiate a transmission method of a conversational service using the IP multimedia subsystem (IMS) according to an embodiment of the present disclosure. The IMS may be shown in FIG. 4a-c. FIG. 5 show the exemplary procedure for the transmitting terminal and the receiving terminal to secure the QoS of a wired and/or wireless transmission path. The transmitting terminal 501 shown in FIG. 5 may be a UE device or an MRF instead of the UE device.

Referring FIG. 5, the transmitting terminal (e.g., UE A) 501 may transmit an SDP request message (e.g., a 1st SDP offer) to the P-CSCF 503, in the service provider A 510, which has an IMS node allocated to the transmitting terminal 501, in the (session initiation protocol, SIP) invite message 520. The invite message 520 may be transmitted to the IMS connected to a counterpart terminal (e.g., UE B) 502 through nodes such as I-CSCF 515, S-CSCF 516, and P-CSCF 517, in the service provider B 511, and finally to the receiving terminal 502.

The receiving terminal 502 may select an acceptable bit rate and a transmission method from among the bit rates provided by the transmitting terminal 501. For an AI based conversational service, the receiving terminal 502 may also select a desired configuration of AI inferencing (together with required AI models and possible intermediate data) according to that offered by the transmitting terminal 501, including the information in a 1st SDP answer message in a SIP 183 message 522 in order to transmit the 1st SDP answer message to the transmitting terminal 501.

In the process of transmitting the SIP 183 message 522 to the transmitting terminal 501, each IMS node may start to reserve transmission resources of the wired and/or wireless networks required for this service, and all the conditions of the session are agreed through additional procedures 524, 526, 530, 532. The transmitting terminal 501 may confirm the transmission resources of all transmission sections. The transmitting terminal 501 that confirms the transmission resource of all transmission sections may be secured and may transmit a media flow 534 to the receiving terminal 502. For example, the media flow 534 may include 360 fisheye image videos but the disclosure is not limited thereto.

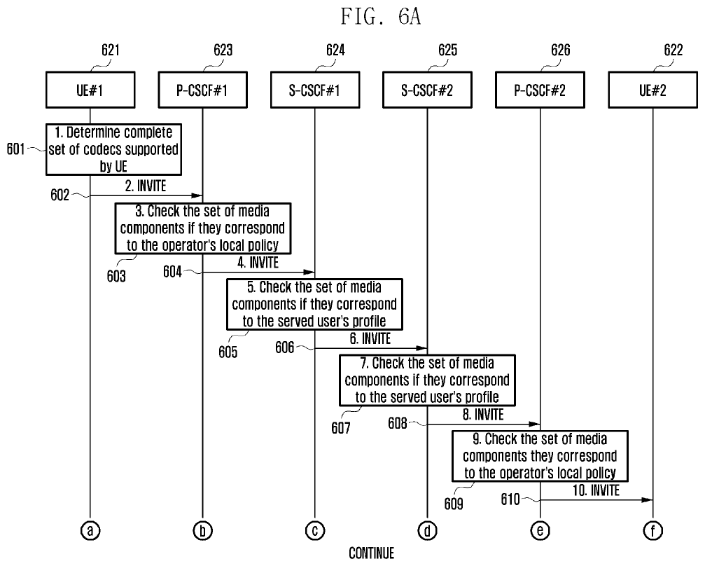

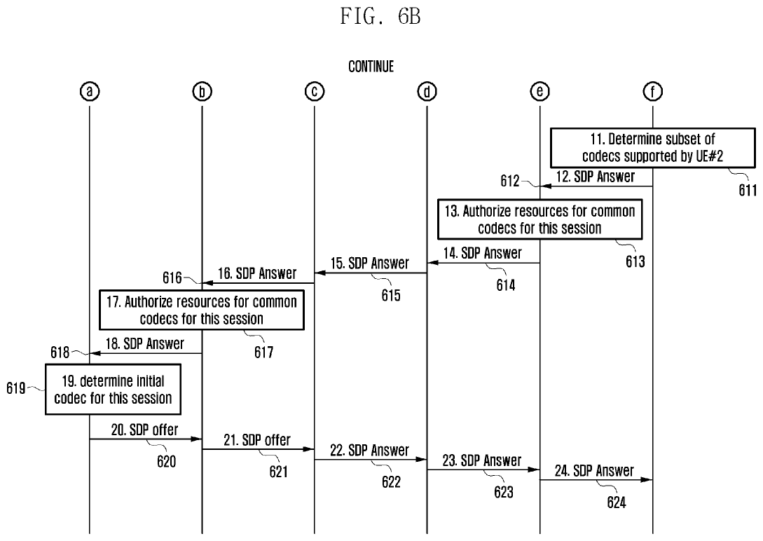

FIGS. 6a and 6b illustrate procedures for establishing an SDP answer by the receiving terminal from an SDP offer transmitted by the transmitting terminal according to an embodiment of the present disclosure. The transmitting terminal 621 shown in FIG. 6 may be a UE device or an MRF instead of the UE device.

Referring FIG. 6, the procedure may include operations as shown in following examples.

In one example, at operation 601, the UE#1 (transmitting terminal) 621 may insert a codec(s) to an SDP payload. The inserted codec(s) may reflect the UE#1's terminal capabilities and user preferences for the session capable of supporting for this session. The UE#1 621 may build an SDP including media parameters (e.g., bandwidth requirements and/or characteristics of each), and may assign local port numbers for each possible media flow. Multiple media flows may be offered, and for each media flow (e.g., “m=” line in SDP), there may be multiple codec choices offered.

In one example, at operation 602, the UE#1 621 may send an initial INVITE message to P-CSCF#1 623 including this SDP.

In one example, at operation 603, the P-CSCF#1 621 may examine the media parameters. If the P-CSCF#1 621 finds media parameters not allowed to be used within an IMS session (based on P-CSCF local policies, or if available bandwidth authorization limitation information coming from a policy and charging rules function (PCRF)/a policy control function (PCF)), the P-CSCF#1 621 may reject the session initiation attempt. The rejection may include sufficient information for originating UE (e.g., the UE#1 621) to re-attempt session initiation with media parameters that are allowed by local policy of P-CSCF#1's network according to the procedures specified in internet engineering task force (IETF) request for comments (RFC) 3261. In this flow described in FIG. 6, the P-CSCF#1 623 may allow the initial session initiation to attempt to continue. Whether a P-CSCF (e.g., the P-CSCF#1 623) interacts with the PCRF/PCF in the operation 603 may be based on operator policy.

In one example, at operation 604, the P-CSCF#1 623 may forward the INVITE message to an S-CSCF#1 624.

In one example, at operation 605, the S-CSCF#1 624 may examine the media parameters. If the S-CSCF#1 624 finds media parameters that local policy or the originating user's subscriber profile does not allow to be used within an IMS session, the S-CSCF#1 624 may reject the session initiation attempt. The rejection may include sufficient information for the originating UE (e.g., the UE#1 621) to re-attempt session initiation with media parameters that are allowed by the originating user's subscriber profile and by local policy of S-CSCF#1's network (e.g., according to the procedures specified in the IETF RFC 3261). In this flow described in FIG. 6, the S-CSCF#1 624 may allow the initial session initiation to attempt to continue.

In one example, at operation 606, the S-CSCF#1 624 may forward the INVITE message, through an S-S session flow procedures, to an S-CSCF#2 625.

In one example, at operation 607, the S-CSCF#2 625 may examine the media parameters. If S-CSCF#2 finds media parameters that local policy or the terminating user's subscriber profile does not allow to be used within an IMS session, the S-CSCF#2 625 may reject the session initiation attempt. The rejection may include sufficient information for the originating UE (e.g., the UE#1 621) to re-attempt session initiation with media parameters that are allowed by the terminating user's subscriber profile and by local policy of S-CSCF#2's network (e.g., according to the procedures specified in the IETF RFC 3261). In this flow described in FIG. 6, the S-CSCF#2 625 may allow the initial session initiation to attempt to continue.

In one example, at operation 608, the S-CSCF#2 625 may forward the INVITE message to a P-CSCF#2 626.

In one example, at operation 609, the P-CSCF#2 626 may examine the media parameters. If the P-CSCF#2 626 finds media parameters not allowed to be used within an IMS session (based on P-CSCF local policies, or if available bandwidth authorization limitation information coming from the PCRF/PCF), the P-CSCF#2 626 may reject the session initiation attempt. The rejection may include sufficient information for the originating UE (e.g., the UE#1 621) to re-attempt session initiation with media parameters that are allowed by local policy of P-CSCF#2's network (e.g., according to the procedures specified in the IETF RFC 3261). In this flow described in FIG. 6, the P-CSCF#2 626 may allow the initial session initiation to attempt to continue. Whether a P-CSCF (e.g., the P-CSCF#2 626) may interact with the PCRF/PCF in the operation 609 may be based on operator policy.

In one example, at operation 610, the P-CSCF#2 626 may forward the INVITE message to UE#2 the 622.

In one example, at operation 611, the UE#2 622 may determine the complete set of codecs that capable of supporting for this session. The UE#2 622 may determine the intersection with those appearing in the SDP in the INVITE message. For each media flow that is not supported, the UE#2 622 may insert an SDP entry for media (“m=” line) with port=0. For each media flow that is supported, the UE#2 622 may insert an SDP entry with an assigned port and with the codecs in common with those in the SDP from the UE#1 621.

In one example, at operation 612, the UE#2 622 may return an SDP response (e.g., SDP Answer) listing common media flows and codecs to the P-CSCF#2 626.

In one example, at operation 613, the P-CSCF#2 626 may authorize the QoS resources for the remaining media flows and codec choices.

In one example, at operation 614, the P-CSCF#2 626 may forward the SDP response to the S-CSCF#2 625.

In one example, at operation 615, the S-CSCF#2 626 may forward the SDP response to the S-CSCF#1 624.

In one example, at operation 616, the S-CSCF#1 623 may forward the SDP response to the P-CSCF#1 623.

In one example, at operation 617, the P-CSCF#1 623 may authorize the QoS resources for the remaining media flows and codec choices.

In one example, at operation 618, the P-CSCF#1 623 may forward the SDP response to the UE#1 621.

In one example, at operation 619, the UE#1 621 may determine which media flows may be used for this session, and which codecs may be used for each of those media flows. If there was more than one media flow, or if there was more than one choice of codec for a media flow, then the UE#1 621 need to renegotiate the codecs by sending another offer to reduce codec to one with the UE#2 622.

In some examples, the UE#1 622 may send the SDP offer message to the UE#2 622, along the signalling path established by the INVITE request.

The remainder of the multi-media session may complete identically to a single media/single codec session if the negotiation results in a single codec per media.

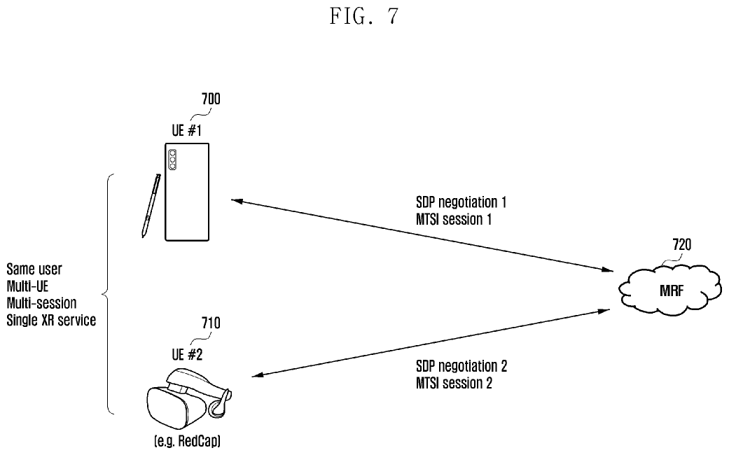

FIG. 7 illustrates a communication system for media services according to an embodiment of the present disclosure. For convenience, it is assumed that the media services shown in FIG. 7 are multi-modal (e.g., multi device) XR services but the disclosure is not limited thereto.

Referring FIG. 7, the communication system may include multi UEs (e.g., UE#1 700 and UE#2 710 (e.g., reduced capability (RedCap) UE) and an MRF (or MRF entity) 720. The MRF 720 may be a media source and the multi UEs 700, 710 may be media destinations or media consumers.

In the example of a multi-UE, multi-session use case for a single real-time XR service shown in FIG. 7, a single user may have two different UE devices (e.g., UE#1 and UE#2) 700, 710, each with 5G modem capable of connecting to the 5GC. The UE#1 and UE#2 are corresponded to the same user and multi-UE multi-session single XR service. As shown in FIG. 7, each UE device 700, 710 may establish an independent multimedia telephony service for IMS (MTSI) session with the MRF 720 (which is assumed to be the same entity for both UEs 700, 710), with separate SDP negotiation procedures. The two different UEs 700, 710 and MTSI sessions may be used to consume the same single XR service (e.g., a multi-UE, multi-session single real-time XR service).

Since both UE devices 700, 710 may pertain to a single XR service, and since each MTSI session may include multiple media streams, certain streams from each session may need to be delivered in a synchronized manner. An embodiment of the disclosure may relate to how to identify and synchronize streams in which the synchronization is needed from different UE MTSI sessions for the multi-UE, multi-session single real-time XR service.

In the example shown in FIG. 7, the MRF 720 may be connected to various different entities depending on the XR service scenario. For example, the MRF 720 may be connected to other users via their UE(s), such as in a real-time XR conversational type service, or the MRF 720 may be connected to a content provider server which provisions XR media in real-time, or any other manner.

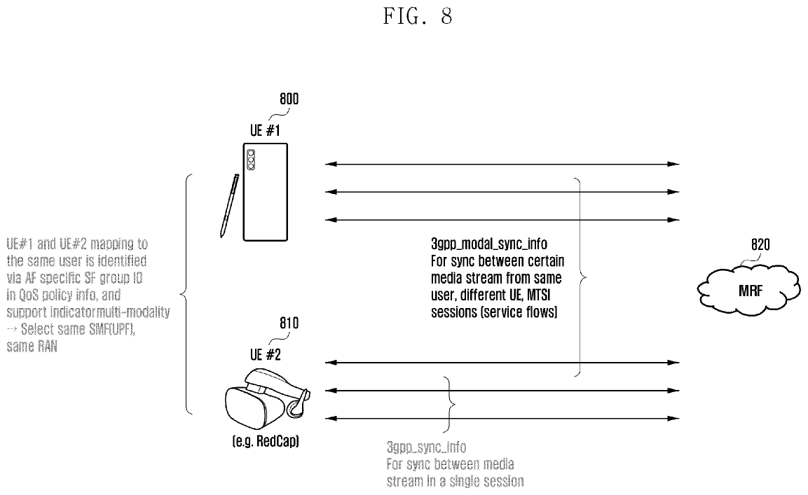

FIG. 8 illustrates a communication system for media services according to an embodiment of the present disclosure. For convenience, it is assumed that the media services shown in FIG. 8 are for a multi-UE, multi-session use case for a single real-time XR service, but the disclosure is not limited thereto.

Referring FIG. 8, the communication system may include UE#1 800, UE#2 (e.g., RedCap UE) 810 and an MRF (or MRF entity) 820. As shown in the FIG. 8, there may be two MTSI sessions for media delivery between the MRF 820 and each corresponding UE 800, 810.

The MRF 820 may act as the media source, and each corresponding UE 800, 810 may act as the media consumer (or the media destination). Each MTSI session established between the MRF 820 and each UE 800, 810 may include multiple media streams, and the multiple media streams may include different media types related to XR (e.g., such as (but not restricted to) audio, 2D video, 3D video (point clouds, meshes, depth information etc)), and such media may be raw uncompressed media data, or may be media data which has been compressed by techniques such as media codecs.

Mapping of the multiple UEs (UE#1 800 and UE#2 810) to the same user may be identified via a group ID (e.g., an application function (AF) specific service function (SF) group ID) in QoS policy information, indicating the support of multi-modality (or multi-modal). If the UE#1 800 and the UE#2 are corresponding to a same value of the group ID, the UE#1 and the UE#2 may be identified as mapped to the same user. If the UE#1 800 and the UE#2 are respectively corresponding to different values of the group ID, the UE#1 and the UE#2 may be identified as unmapped to the same user (or mapped to different users, respectively). The UE#1 800 and the UE#2 may support multi-modality support indicator. In other words, multi-modal service may be supported by the UE#1 800 and the UE#2. In the presence of such a group ID (e.g., the AF specific SF group ID), the same session management function (SMF) (user plane function (UPF)) and same RAN may be selected for both UEs 800, 810.

Synchronization of media streams within a single session (e.g., single MTSI session) for a single UE may be supported by 3gpp_sync_info attribute as noted in TS 26.114. The 3gpp_sync_info attribute may be for synchronization between media streams in the single session.

In an embodiment of the disclosure, certain media streams for two different UE devices may require synchronization with each other.

Need for synchronization of different streams may be dependent on the media types of the streams (which may also be of the same media type). For example, synchronization of 3D video and audio may require the synchronization.

A synchronization jitter requirement for the different streams may also be dependent on the media types of the streams. For example, synchronization of an interaction media type and a haptic media type typically has a tighter synchronization jitter requirement compared to that of synchronization between an interaction media type and a 3D video media type. In the disclosure, the synchronization jitter (also known as synchronization or inter-media skew) may be defined as an amount of synchronization delay between media streams that needs to be maintained during the synchronization process (at the receiver side), which is acceptable to a session (or the sender of the multimedia streams) for a good user experience.

The media streams which require synchronization may need to be identified such that the UE devices may handle the media streams accordingly (e.g., by the media decoder, where needed, and also the media player, as well as the XR application for dealing with such media).

There may be multiple groups of media streams within a multi-UE, multi-modal XR service which need synchronization separately. These groups of media streams may also need to be identified.

Identification of a multi-UE, multi-modal service session may be required such that the UE XR application may process the service accordingly. The identification may be included in an SDP offer transmitted by the MRF and received by a UE.

Identification of media streams which require synchronization, and with what requirements (such as synchronization jitter, and/or media latency (or synchronization latency)). The identification may be also included in the SDP offer transmitted by the MRF and received by a UE.

The attributes and parameters for of an embodiment of the disclosure above may be specified below.

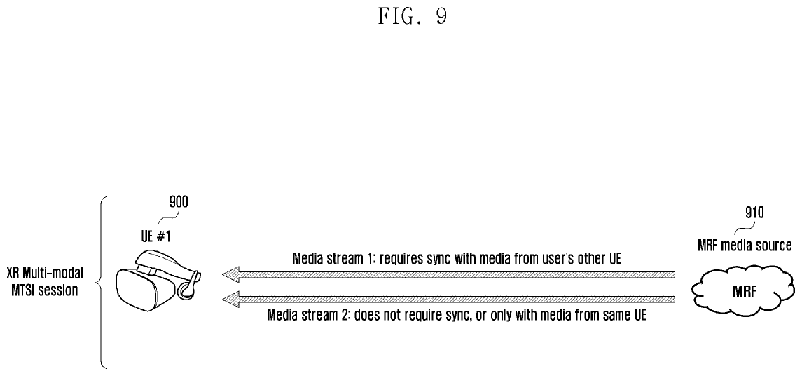

FIG. 9 illustrates a communication system for media services according to an embodiment of the present disclosure. For convenience, it is assumed that the media services shown in FIG. 9 are provided via XR multi-modal MTSI session, but the disclosure is not limited thereto. Referring FIG. 9, the communication system may include UE#1 900 and an MRF (or MRF entity) 910 as a media source.

An embodiment of the disclosure, the SDP procedure may include transmission/reception of an SDP offer message and transmission/reception of an SDP answer message. At session level, the SDP offer message may related to determining whether session includes multi-modal streams associated with another UE different from a UE receiving the SDP offer message. The SDP offer message may include a list of available XR media streams (e.g., XR media such as video, audio, point clouds, meshes, pose info, etc.) at MRF for different media, capabilities and/or bandwidths. At m-line level, the SDP offer message may related to an indication of whether media stream requires multi-modal synchronization. At m-line level, the SDP offer message may also related to indicating requirements of synchronization. The SDP answer may include desired XR media streams selected by the UE. The MRF may send/transmit the desired XR media streams to the UE according to synchronization requirements as an SDP negotiation result.

An embodiment of the disclosure may define multiple media streams for multiple UEs, for a single user and XR service. In the multiple media streams, certain streams may require synchronization, and other certain streams do not require the synchronization. For example, as shown in FIG. 9, Media stream 1 may require tight synchronization with one or more media streams from other UE corresponding a same user with the UE#1. In contract, media stream 2 may not have such a requirement. Accordingly, the media stream 2 may not require tight synchronization with one or more media streams from other UE corresponding a same user with the UE#1. The media stream 2 may still require synchronization with media streams received by the same UE (e.g., the UE#1 900).

In an embodiment of the disclosure, the MRF 910 may transmit an SDP offer (or an SDP offer message) to a UE device (e.g., the UE#1 900). The SDP offer may include at least one of:
At session level: information to determine whether the MTSI session includes multi-modal streams associated with another UE;
A list of available XR media streams from the MRF 910 for different media types, media capabilities, and/or associated bandwidths;

1At media line (m-line) level: information to determine whether the corresponding media stream (m-line) requires multi-modal synchronization (i.e., synchronization of media streams received by different UE devices); or
At the media line (m-line) level: information indicating requirements of synchronization between media streams which require multi-modal synchronization (i.e., synchronization jitter, and/or synchronization latency).

XR media streams for the SDP offer according to an embodiment of the disclosure may include XR media (e.g., such as video, audio, 3D video, point clouds, meshes, pose information, haptic information, or any other XR related media).

In an embodiment of the disclosure, the UE device (e.g., the UE#1 900) may transmit an SDP answer if the UE device receives the SDP offer from the MRF 910. The UE device may select desired XR media streams from the SDP offer and the UE device may include the selected XR media streams into the SDP answer.

An SDP negotiation may be complete through transmission and reception of the SDP offers and the SDP answers. Once the SDP negotiation is complete, the MRF 910 may transmit the multi-modal XR streams to the corresponding UEs, according to the multi-modal synchronization requirements. On receipt of the media streams, the UE device (e.g., UE#1) may also process and present (media presentation) the media streams according to the same multi-modal synchronization requirements.

At the SDP session level, an embodiment of the present disclosure may define a multi-modal attribute (e.g., 3gpp_multimodal_info). The multi-modal attribute may indicate a multi-modal session for the UE and the XR application. The attribute may identify the multi-modal service session on an application level of the UE. By including a unique ID (e.g., ID-value under the multi-modal attribute), more than one multi-modal service may be supported by multiple MTSI sessions on the same UE device (identified by the presence of the attribute in both MTSI sessions, albeit with different unique ID values as defined in the syntax and semantics under table 1.

The syntax and semantics for the parameters under the attribute may be defined under table 1.

TABLE 1
3gpp_multimodal_info attribute:

In a multi-modal service (e.g. XR multi-modal real-time service), a user uses multiple UE devices, each with 5G modem
capabilities, and each connected to the multi-modal service via independent MTSI sessions with a common MRF. In this
situation, the multi-modal info attribute is used to indicate to the application that the MTSI session being negotiated is
part of a multi-modal service involving one or more other UE devices.
The ABNF for the multi-modal info attribute is described as follows:
Multi-modal-Info = “a” “=” “3gpp_multimodal_info” “:” ID-value”
ID-value = “0”/“1”/“2” . . .
The integer value indicated by “ID-value” corresponds to an identifier for the multi-modal service, for which the identifier
shall be the same unique value for all MTSI sessions (across different multiple UEs) corresponding to a same given multi-
modal service.
The parameter “3gpp_multimodal_info” should be included in the SDP at the session level before any media level m-lines.

An embodiment of the disclosure may define a multi-modal synchronization attribute (e.g., 3gpp_modal_sync_info). The attribute may identify and define the corresponding media stream as one that requires multi-modal synchronization.

The integer value indicated by the “ID-value” parameter under/included in the attribute may correspond to an identifier for a group of multi-modal media streams which have the synchronization requirement as indicated by the “sync-jitter.” For a given multi-modal media service, there may be multiple multi-modal synchronization groups between the multiple UEs/MTSI sessions, each with a corresponding unique value indicated by “ID-value.”

The “sync_jitter” parameter under/included in the attribute may indicate the multi-modal synchronization requirement between the relevant media streams. For example, the “sync_jitter” parameter may indicate the multi-modal synchronization requirement through two values indicating a range for the synchronization jitter (e.g 5 ms˜10 ms). For another example, the “sync jitter” parameter may indicate the multi-modal synchronization requirement through one threshold value, an integer value, indicating a threshold for the synchronization jitter (e.g., 10 ms).

The “sync_latency” parameter under/included in the attribute may indicate the latency requirement of the media stream taking into account the synchronization jitter requirement. The latency requirement may be calculated by the MRF. For example, the latency requirement may be defined and/or indicated through two values indicating a range (e.g 5 ms˜10 ms) for the latency. For another example, the latency requirement may be defined and/or indicated through one threshold value indicating the threshold for the latency.

The “sync_jitter” parameter may be corresponded to the unique value indicated by “ID-value.”

The attribute/parameter “3gpp_modal_sync_info” may be included in the SDP at the session level and/or at the media level. The usage of the attribute may be governed by the following rules.

In one example, at the session level, the “3gpp_modal_sync_info” attribute may be used with a group attribute defined in RFC 3388, or any other group attribute defined for the related cause/application. The group attribute may indicate to the receiver which streams (identified by their media ID (mid) attributes) that to be synchronized. The “3gpp_modal_sync_info” attribute may follow the “group: LS” line (if the group attribute defined in RFC 3388 is used), or the corresponding group attribute line defined for the related cause/application (if any other group attribute defined for the related cause/application is used). At the session level, the “3gpp_modal_sync_info” attribute may include an identifier for the multimodal synchronization group. At the session level, the “3gpp_modal_sync_info” attribute may include a value for the synchronization jitter applicable to all media streams under the specified group.

In one example, at the media level, the “3gpp_modal_sync_info” may include an identifier for the multimodal synchronization group, a value for the synchronization jitter applicable to the media stream, and/or a value for the synchronization latency applicable to the media stream.

In one example, if the “3gpp_modal_sync_info” attribute is defined at both session level (with the “group” attribute) and media level, the media level attribute values for “sync-jitter” and “sync-latency” may override the session level attribute values for “sync-jitter” and “sync-latency.” The “ID-value” may be identical in both session level and media level attributes if the corresponding mid is included into the group attribute used at the session level.

The syntax and semantics for the parameters under the attribute may defined under table 2.

TABLE 2
3gpp_modal_sync_info attribute

Tight synchronization between the constituent streams is not necessary for all streams within the MTSI sessions of a
multi-modal media service. For instance, during a multi-modal AR service, the service may consist of two MTSI sessions
from two different UEs used by the user: an AR glasses UE and a mobile phone UE. In this situation, the individual MTSI
sessions established by each UE device and the network entity (typically a common MRF) cach may consist of multiple
media streams. The sender (e.g. MRF) may define the synchronization of certain streams from these sessions between
the different UE devices. The Multimodal Synchronization Info attribute defined in the present document is not just
limited to lip-sync between audio/video streams, but is also applicable to any two or more media streams that need to be
synchronized during a multiple UE device, multiple MTSI session, multi-modal media service. Such media streams may
include XR media such as 3D related video, depth (map) information, pose information, sensory information, interactivity
event related information, haptic information, and any other XR related media information. This attribute allows an MTSI
client (typically and MRF) to specify which media streams from which UE device/MTSI session should be synchronized
together, and with what allowed synchronization jitter (or synchronization delay) requirement.
NOTE: the synchronization requirements typically depend on the nature of the media types which are defined to be
synchronized, for example, synchronization of an interaction media type and a haptic media type typically has a tighter
synchronization jitter requirement compared to that of synchronization between an interaction media type and a 3D video
media type
In case the choice is to have synchronization between different streams, it is up to the implementation, use case and
application to decide on how to achieve the synchronization jitter allowed between the streams to synchronize. For the
synchronization of media streams within a single UE device and MTSI session (without the synchronization requirement
with another UE's MTSI session) the conventional “3gpp_sync_info” attribute may be used, even if the media stream
exists under a multi-modal media service MTSI session. The ABNF for the multimodal synchronization info attribute is
described as follows:
Multimodal-Sync-Info = “a” “=” “3gpp_modal_sync_info” “:” ID-value”,“sync-jitter”,“sync-latency”
ID-value = “0”/“1”/“2” . . .
sync-jitter = range/integer
sync-latency = range/integer
The integer value indicated by “ID-value” corresponds to an identifier for the group of multi-modal media streams which
have the synchronization requirement as indicated by “sync-jitter”. For a given multi-modal media service, there may be
multiple multi-modal synchronization groups between the multiple UEs/MTSI sessions, each with a corresponding
unique value indicated by “ID-value”.
The parameter “3gpp_modal_sync_info” should be included in the SDP at the session level and/or at the media level. Its
usage is governed by the following rules:

| | |
|---|---|
| 1. | At the session level, the “3gpp_modal_sync_info” attribute shall be used with the group attribute defined in RFC |
| | 3388, or any other group attribute defined for the related cause/application. The group attribute indicates to the |
| | receiver which streams (identified by their mid attributes) that that to be synchronized. The |
| | “3gpp_modal_sync_info” attribute shall follow the “group: LS” line (when the group attribute defined in RFC 3388 |
| | is used), or the corresponding group attribute line defined for the related cause/application. At the session level, the |
| | “3gpp_modal_sync_info” attribute shall include an identifier for the multimodal synchronization group, and may |
| | include a value for the synchronization jitter applicable to all media streams under the this specified group. |
| 2. | At the media level, the “3gpp_modal_sync_info” may include the identifier for the multimodal synchronization |
| | group, a value for the synchronization jitter applicable to the media stream, and a value for the synchronization |
| | latency applicable to the media stream. |
| 3. | When the “3gpp_modal_sync_info” attribute is defined at both session level (the with “group” attribute) and media |
| | level, then the media level attribute values for “sync-jitter” and “sync-latency” shall override the session level |
| | attribute. The “ID-value” shall be identical in both session level and media level attributes if the corresponding mid |
| | is included into the group attribute used at the session level. |

An exemplary for the UE receiving an SDP offer (an SDP offer message) including at least one attribute and/or parameter according to an embodiment of the disclosure is discussed below.

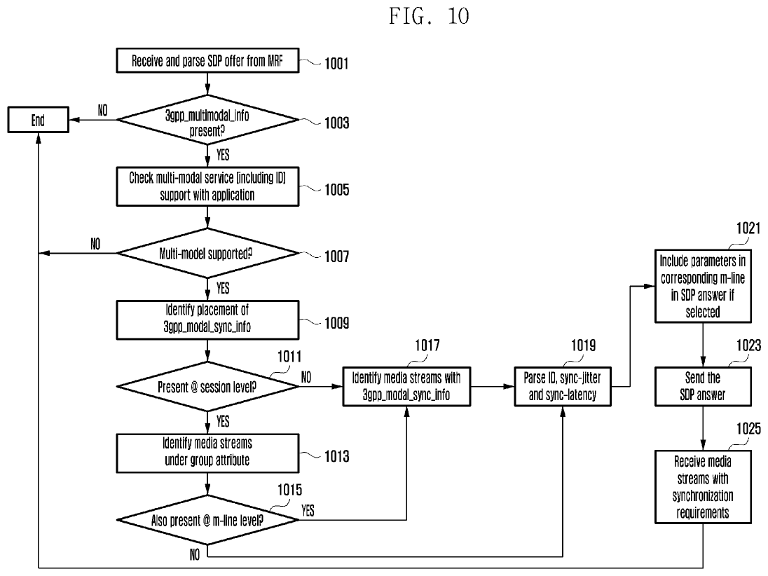

FIG. 10 illustrates an operation for a UE according to an embodiment of the present disclosure. The exemplary operation shown in FIG. 10 relates to a UE operation if both the attribute “3gpp_multimodal_info” and the attribute “3gpp_modal_sync_info” are available to be used for synchronization. If both the attribute “3gpp_multimodal_info” and the attribute “3gpp_modal_sync_info” are used, the attribute “3gpp_multimodal_info” may be a session level attribute and the attribute “3gpp_modal_sync_info” may be a media level attribute.

Referring FIG. 10, at operation 1001, the UE may receive the SDP offer from the MRF. The UE may parse the SDP offer from the MRF to determine whether the attribute “3gpp_multimodal_info” is present 1003 (e.g., whether the attribute “3gpp_multimodal_info” is included in the SDP offer or not). If the attribute “3gpp_multimodal_info” is not present (e.g., the attribute “3gpp_multimodal_info” is not included in the SDP offer), the operation for the UE may be ended.

At operation 1005, if the attribute “3gpp_multimodal_info” is present (e.g., the attribute “3gpp_multimodal_info” is included in the SDP offer), the UE may check/identify whether multi-modal service is supported with application. The multi-modal service may include ID. In other words, the multi-modal service may be identified by the ID. If the multi-modal service is not supported, the operation for the UE may be ended.

At operation 1009, if the multi-modal service is supported, the UE may identify a placement of the attribute “3gpp_multimodal_info.” In other words, the UE may identify whether the attribute “3gpp_multimodal_info” presents at session level 1011 and/or m-line level (or media level) 1015. If the attribute “3gpp_multimodal_info” does not present at session level, the attribute “3gpp_multimodal_info” may be identified as being provided at m-line level and the UE may operate as operation 1017.

At operation 1013, if the attribute “3gpp_multimodal_info” presents at session level, the UE may identify media streams under group attribute. If the “3gpp_multimodal_info” also presents at m-line level, the UE may operate as operation 1017. If the attribute “3gpp_multimodal_info” presents at session level but does not present at m-line level, the UE may operate as operation 1019.

At operation 1017, the UE may identify media streams with the attribute “3gpp_modal_sync_info.” At operation 1019, the UE may parse ID (e.g., ID-value), sync-jitter and/or sync-latency based on the attribute “3gpp_modal_sync_info.” At operation 1021, the UE may include parameters in corresponding m-line in an SDP answer if selected. The UE may select at least one media stream among a list of media streams included in the SDP offer and may generate the SDP answer parameters corresponding to the selected at least one media stream.

At operation 1023, the UE may transmit/send the SDP answer. At operation 1025, the UE may receive media stream with synchronization requirement.

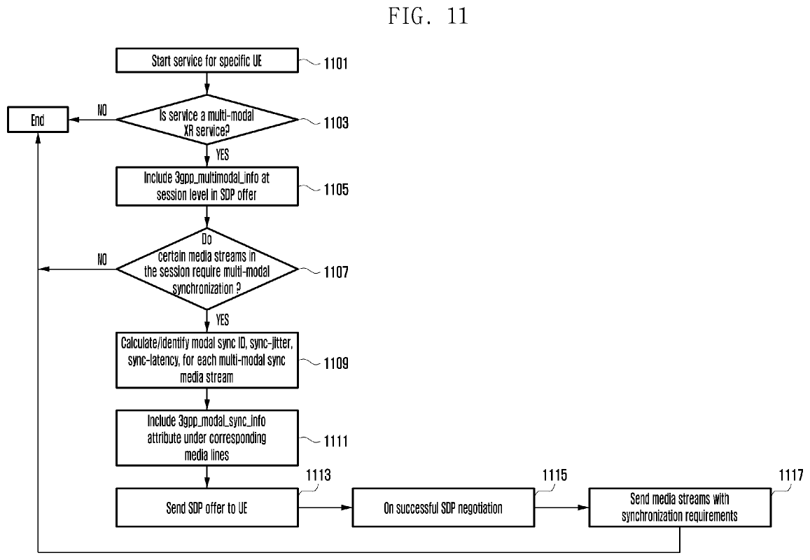

FIG. 11 illustrates an operation for a MRF according to an embodiment of the present disclosure. The exemplary embodiment shown in FIG. 11 relates to a MRF operation if both the attribute “3gpp_multimodal_info” and the attribute “3gpp_modal_sync_info” are available to be used for synchronization. In other words, the exemplary embodiment shown in FIG. 11 relates to the MRF operation corresponding to the UE procedure shown in FIG. 10.

Referring FIG. 11, at operation 1101, the MRF may start service for specific UE. At operation 1103, the MRF may identify whether the service is a multi-modal XR service. If the service is not the multi-modal XR service, the operation for the MRF may be ended.

At operation 1105, if the service is the multi-modal XR service, the MRF may include the attribute “3gpp_multimodal_info” at session level in the SDP offer. The MRF may process the SDP offer to include the attribute “3gpp_multimodal_info.” The MRF may identify whether certain media streams in session require multi-modal synchronization 1107. If the certain media streams do not require the multi-modal synchronization, the operation for the MRF may be ended.

At operation 1109, if the certain media streams require the multi-modal synchronization, the MRF may calculate/identify modal synchronization ID, synchronization jitter and/or synchronization latency for each multi-modal synchronization media stream related to the certain media streams.

At operation 1111, the MRF may include the attribute “3gpp_modal_sync_info” under corresponding media line in the SDP offer. The MRF may process the SDP offer to include the attribute “3gpp_modal_sync_info.” At operation 1113, the MRF may send/transmit the SDP offer to the UE. At operation 1115, the MRF may receive an SDP answer from the UE and may identify that the SDP negotiation is successful. At operation 1117, the MRF may send/transmit media streams with synchronization requirements.

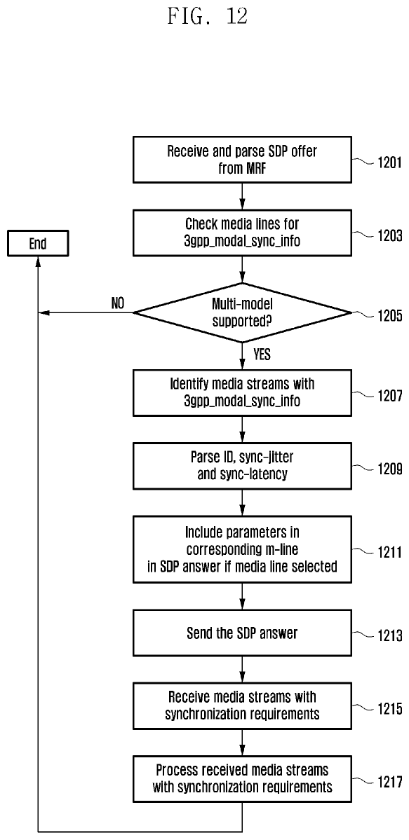

FIG. 12 shows an exemplary operation for a UE according to an embodiment of the disclosure. The exemplary operation shown in FIG. 12 relates to a UE operation if the attribute “3gpp_modal_sync_info” is used for synchronization without the attribute “3gpp_multimodal_info.”

Referring FIG. 12, at operation 1201, the UE may receive and parse the SDP offer from the MRF. The UE may parse the SDP offer from the MRF.

At operation 1203, the UE may check media lines for the attribute “3gpp_modal_sync_info.” The UE may identify whether multi-modal service is supported 1205. If the multi-modal service is not supported, the operation for the UE may be ended.

At operation 1207, If the multi-modal service is supported, the UE may identify media streams with the attribute “3gpp_modal_sync_info.”

At operation 1209, the UE may parse ID (e.g., “ID-value” in the attribute “3gpp_modal_sync_info”), a synchronization jitter and/or a synchronization latency.

At operation 1211, the UE may include parameters in corresponding m-line in an SDP answer if selected. The UE may select at least one media stream (or at least one media line) among a list of media streams included in the SDP offer and may generate the SDP answer parameters corresponding to the selected at least one media stream.

At operation 1213, the UE may send/transmit the SDP answer. At operation 1215, the UE may receive media streams with synchronization requirements. At operation 1217, the UE may process received media streams with synchronization requirements.

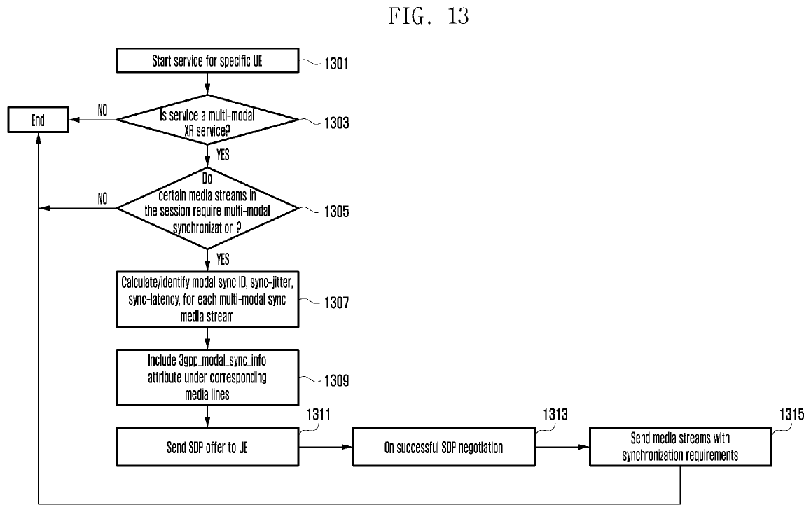

FIG. 13 illustrates an operation for a MRF according to an embodiment of the present disclosure. The exemplary embodiment shown in FIG. 13 relates to a MRF operation if the attribute “3gpp_modal sync_info” is used for synchronization without the attribute “3 gpp_multimodal_info.” In other words, the exemplary embodiment shown in FIG. 13 relates to the MRF operation corresponding to the UE procedure shown in FIG. 12.

Referring FIG. 13, at operation 1301, the MRF may start service for specific UE. At operation 1303, the MRF may identify whether the service is a multi-modal XR service. If the service is not the multi-modal XR service, the operation for the MRF may be ended.

At operation 1305, the MRF may identify whether certain media streams in session require multi-modal synchronization. If the certain media streams do not require the multi-modal synchronization, the operation for the MRF may be ended.

At operation 1307, if the certain media streams require the multi-modal synchronization, the MRF may calculate/identify modal synchronization ID, synchronization jitter and/or synchronization latency for each multi-modal synchronization media stream related to the certain media streams.

At operation 1309, the MRF may include the attribute “3gpp_modal_sync_info” under corresponding media line in the SDP offer. The MRF may process the SDP offer to include the attribute “3gpp_modal_sync_info.” At operation 1311, the MRF may send/transmit the SDP offer to the UE. At operation 1313, the MRF may receive an SDP answer from the UE and may identify that the SDP negotiation is successful. At operation 1315, the MRF may send/transmit media streams with synchronization requirements.

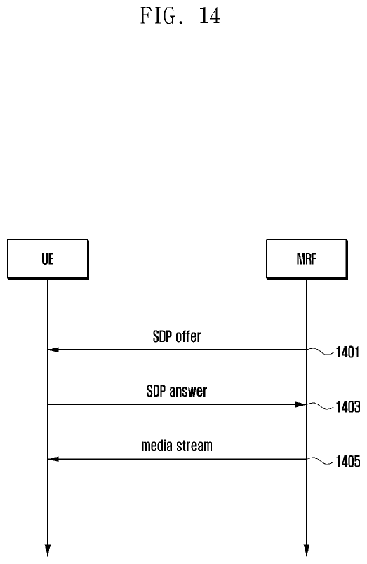

FIG. 14 illustrates a method of a UE and a node according to an embodiment of the present disclosure. The node may be an MRF or an MRF entity.

Referring FIG. 14, at operation 1401, the MRF may transmit an SDP offer message and the UE may receive the SDP offer message. The SDP offer message may include information (or an attribute) including an identifier for a group of a plurality of media streams.

At operation 1403, the UE may transmit an SDP answer message in response to the SDP offer message and the MRF may receive the SDP answer.

At operation 1405, the MRF may transmit at least one media stream and the UE may receive the at least one media stream. If the at least one media stream is included in the plurality of media streams, the at least one media stream may be transmitted/received related to a synchronization requirement. The synchronization requirement may be satisfied between the at least one media stream. The synchronization requirement may be related to the information.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

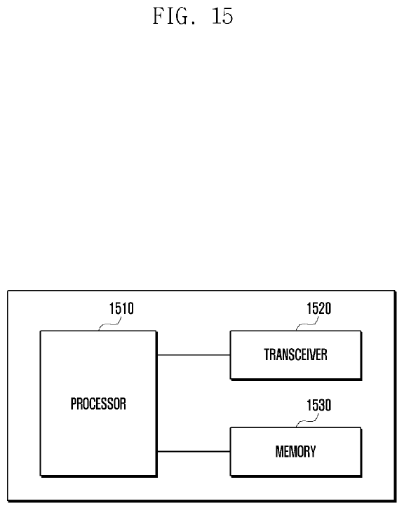

FIG. 15 illustrates an electronic device according to an embodiment of the present disclosure.

Referring to the FIG. 15, the electronic device 1500 may include a processor 1510, a transceiver 1520 and a memory 1530. However, all of the illustrated components are not essential. The electronic device 1500 may be implemented by more or less components than those illustrated in FIG. 15. In addition, the processor 1510 and the transceiver 1520 and the memory 1530 may be implemented as a single chip according to another embodiment.

The electronic device 1500 may correspond to the UE described above.

The aforementioned components will now be described in detail.

The processor 1510 may include one or more processors or other processing devices that control the provided function, process, and/or method. Operation of the electronic device 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the electronic device 1500. The memory 1530 may be connected to the processor 1510 and store at least one instruction or a protocol or a parameter for the provided function, process, and/or method. The memory 1530 may include read-only memory (ROM) and/or random access memory (RAM) and/or hard disk and/or CD-ROM and/or DVD and/or other storage devices.

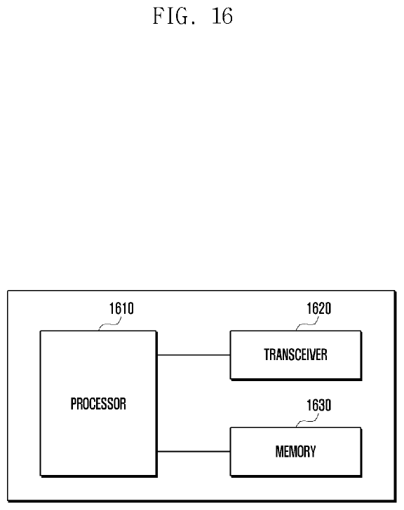

FIG. 16 illustrates a node according to an embodiment of the present disclosure.

Referring to the FIG. 16, the node 1600 may include a processor 1610, a transceiver 1620 and a memory 1630. However, all of the illustrated components are not essential. The node 1600 may be implemented by more or less components than those illustrated in FIG. 16. In addition, the processor 1610 and the transceiver 1620 and the memory 1630 may be implemented as a single chip according to another embodiment.

The node 1600 may correspond to the base station and/or the MRF described above.

The aforementioned components will now be described in detail.

The processor 1610 may include one or more processors or other processing devices that control the provided function, process, and/or method. Operation of the node 1600 may be implemented by the processor 1610.

The transceiver 1620 may include a RF transmitter for up-converting and amplifying a transmitted signal, and a RF receiver for down-converting a frequency of a received signal. However, according to another embodiment, the transceiver 1620 may be implemented by more or less components than those illustrated in components.

The transceiver 1620 may be connected to the processor 1610 and transmit and/or receive a signal. The signal may include control information and data. In addition, the transceiver 1620 may receive the signal through a wireless channel and output the signal to the processor 1610. The transceiver 1620 may transmit a signal output from the processor 1610 through the wireless channel.

The memory 1630 may store the control information or the data included in a signal obtained by the node 1600. The memory 1630 may be connected to the processor 1610 and store at least one instruction or a protocol or a parameter for the provided function, process, and/or method. The memory 1630 may include read-only memory (ROM) and/or random access memory (RAM) and/or hard disk and/or CD-ROM and/or DVD and/or other storage devices.

Although the disclosure has been described with exemplary embodiments, various changes and modifications may be suggested to one skilled in the art. It is intended that the disclosure encompass such changes and modifications as fall within the scope of the appended claims. None of the description in this application should be read as implying that any particular element, step, or function is an essential element that must be included in the claims scope. The scope of patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network entity in a communication system, the method comprising:
transmitting, to a first terminal, a session description protocol (SDP) offer message, wherein the SDP offer message comprises first information including a first identifier for a group of a first plurality of media streams;
receiving, from the first terminal, an SDP answer message associated with the SDP offer message; and
transmitting, to the first terminal, at least one first media stream,
wherein the at least one first media stream is associated with a synchronization requirement in case that the at least one first media stream is included in the first plurality of media streams.

2. The method of claim 1, further comprising transmitting, to a second terminal, at least one second media stream,
wherein, in case that the at least one first media stream and the at least one second media stream are included in the first plurality of media streams, the at least one first media stream and the at least one second media stream are synchronized, and
wherein the synchronization requirement is satisfied between the at least one first media stream and the at least one second media stream.

3. The method of claim 2, wherein, in case that the at least one first media stream and the at least one second media stream are included in the first plurality of media streams, the first terminal and the second terminal correspond to a same application function (AF) specific service function (SF) group identifier.

4. The method of claim 1, wherein the first information further includes information associated with the synchronization requirement,
wherein the information associated with the synchronization requirement includes at least one of:
information on a synchronization jitter associated with synchronization delay for the first plurality of media streams; or
information on a synchronization latency associated with latency requirement for the first plurality of media streams.

5. The method of claim 1, wherein the SDP offer message further comprises second information including a second identifier for a multi-modal service,
wherein a value of the second identifier is same as a value for a plurality of sessions associated with the multi-modal service and the first terminal, and
wherein the first plurality of media streams is included in one session among the plurality of sessions.

6. The method of claim 1, wherein the SDP offer message further comprises information associated with a list of a second plurality of media streams,
wherein the first plurality of media streams is included in the second plurality of media streams, and
wherein the SDP answer message comprises information associated with the at least one first media stream included in the second plurality of media streams.

7. A network entity in a communication system, the network entity comprising:
a transceiver; and
a processor coupled with the transceiver and configured to:
transmit, to a first terminal, a session description protocol (SDP) offer message, wherein the SDP offer message comprises first information including a first identifier for a group of a first plurality of media streams,
receive, from the first terminal, an SDP answer message associated with the SDP offer message, and
transmit, to the first terminal, at least one first media stream,
wherein the at least one first media stream is associated with a synchronization requirement in case that the at least one first media stream is included in the first plurality of media streams.

8. The network entity of claim 7, wherein the processor is further configured to transmit, to a second terminal, at least one second media stream, and
wherein in case that the at least one first media stream and the at least one second media stream are included in the first plurality of media streams, and
wherein the synchronization requirement is satisfied between the at least one first media stream and the at least one second media stream.

9. The network entity of claim 8, wherein, in case that the at least one first media stream and the at least one second media stream are included in the first plurality of media streams, the first terminal and the second terminal correspond to a same application function (AF) specific service function (SF) group identifier.

10. The network entity of claim 7, wherein the first information further includes information associated with the synchronization requirement,
wherein the information associated with the synchronization requirement includes at least one of:
information on a synchronization jitter associated with synchronization delay for the first plurality of media streams; or
information on a synchronization latency associated with latency requirement for the first plurality of media streams.

11. The network entity of claim 7, wherein the SDP offer message further comprises second information including a second identifier for a multi-modal service,
wherein a value of the second identifier is same as a value for a plurality of sessions associated with the multi-modal service and the first terminal, and
wherein the first plurality of media streams is included in one session among the plurality of sessions.

12. The network entity of claim 7, wherein the SDP offer message further comprises information associated with a list of a second plurality of media streams,
wherein the first plurality of media streams is included in the second plurality of media streams, and
wherein the SDP answer message comprises information associated with the at least one first media stream included in the second plurality of media streams.

13. A method performed by a terminal in a communication system, the method comprising:
receiving, from a network entity, a session description protocol (SDP) offer message, wherein the SDP offer message comprises first information including a first identifier for a group of a first plurality of media streams;
transmitting, to the network entity, an SDP answer message associated with the SDP offer message; and
receiving, from the network entity, at least one first media stream,
wherein the at least one first media stream is associated with a synchronization requirement in case that the at least one first media stream corresponds to the first identifier.

14. The method of claim 13, wherein the first information further includes information associated with the synchronization requirement,
wherein the information associated with the synchronization requirement includes at least one of:
information on a synchronization jitter associated with synchronization delay for the first plurality of media streams; or
information on a synchronization latency associated with latency requirement for the first plurality of media streams.

15. The method of claim 13, wherein the SDP offer message further comprises second information including a second identifier for a multi-modal service,
wherein a value of the second identifier is same as a value for a plurality of sessions associated with the multi-modal service and the terminal, and
wherein the first plurality of media streams is included in one session among the plurality of sessions.

16. The method of claim 13, wherein the SDP offer message further comprises information associated with a list of a second plurality of media streams,
wherein the first plurality of media streams is included in the second plurality of media streams, and
wherein the SDP answer message comprises information associated with the at least one first media stream included in the second plurality of media streams.

17. A terminal in a communication system, the terminal comprising:
a transceiver; and
a processor coupled with the transceiver and configured to:
receive, from a network entity, a session description protocol (SDP) offer message, wherein the SDP offer message comprises first information including a first identifier for a group of a first plurality of media streams,
transmit, to the network entity, an SDP answer message associated with the SDP offer message, and
receive, from the network entity, at least one first media stream,
wherein the at least one first media stream is associated with a synchronization requirement in case that the at least one first media stream corresponds to the first identifier.

18. The terminal of claim 17, wherein the first information further includes information associated with the synchronization requirement,
wherein the information associated with the synchronization requirement includes at least one of:
information on a synchronization jitter associated with synchronization delay for the first plurality of media streams; or
information on a synchronization latency associated with latency requirement for the first plurality of media streams.

19. The terminal of claim 17, wherein the SDP offer message further comprises second information including a second identifier for a multi-modal service,
wherein a value of the second identifier is same as a value for a plurality of sessions associated with the multi-modal service and the terminal, and
wherein the first plurality of media streams is included in one session among the plurality of sessions.

20. The terminal of claim 17, wherein the SDP offer message further comprises information associated with a list of a second plurality of media streams,
wherein the first plurality of media streams is included in the second plurality of media streams, and
wherein the SDP answer message comprises information associated with the at least one first media stream included in the second plurality of media streams.
